(19) United States
(12) Patent Application Publication
(10) Pub. No.: US 2026/0246784 A1
(43) Pub. Date: Aug. 20, 2026

(54) METHOD AND DEVICE FOR DEPLOYING A SECURITY FUNCTION FOR AT LEAST ONE CLIENT DEVICE

(71) Applicant: Orange, Issy-les-Moulineaux (FR)

(72) Inventors: Jean-Philippe Wary, Chatillon (FR); Chrystel Gaber, Chatillon (FR)

(21) Appl. No.: 19/474,673

(22) PCT Filed: Apr. 11, 2024
(86) PCT No.: PCT/EP2024/059911

§ 371 Date: Oct. 10, 2025

(30) Foreign Application Priority Data
Apr. 14, 2023 (FR) FR2303747

(51) Int. Cl. H04L 9/40

(52) U.S. Cl. CPC H04L 63/105; H04L 63/0428

(57) ABSTRACT

A method for deploying a security function for at least one client device connected to a communication network is described, the security function being intended to secure a service implemented in said client device. The method is implemented by a device of an infrastructure operator of the communication network, and includes generating at least one first security function for the at least one client device based on a security level required by the service, and on functional capabilities of the client device, and deploying the at least one first security function in the at least one client device in order to guarantee the implementation of the service.

### TECHNICAL FIELD

The present invention concerns the generation of security functions for securing a service provided by a service provider and used by a client terminal.

### PRIOR ART

The multiplicity of electronic terminals, such as mobile phones, smart devices (IOTS), Secure Elements such as SIM cards or Trusted Execution Environments (TEEs), whose capabilities are sometimes limited, means that the devices on the market are incompatible with the security level required by service providers. Consequently, they cannot achieve high levels of assurance, such as bank card assurance. Renewing equipment collections comprising thousands of devices that do not have the security levels required to meet new security needs has a cost that is too prohibitive to be implemented. There is therefore a need to raise the security level of certain devices in order to enable these devices to use services requiring a higher security level than that available in these devices.

### DISCLOSURE OF THE INVENTION

For this purpose, the present invention relates to a method for deploying a security function for at least one client device connected to a communication network, said security function being intended to secure a service implemented in said client device, the method being implemented by a device of an infrastructure operator of said communication network, and comprising:
generating at least one first security function for said at least one client device on the basis of a security level required by said service, and the functional capabilities of said client device,
deploying said at least one first security function in said at least one client device to guarantee implementation of said service.

According to certain embodiments, the method comprises:
generating at least one second security function, said first security function and said second security function collaborating to encode, decode or verify data of the service to be secured between said client device and a service provider providing said service, when implementing the service
deploying said at least one second security function in said service on a server of said service provider.

According to certain embodiments, the method comprises:
a request from a service provider to obtain a security function dedicated to one or all of the services it provides,
generating a third security function (G′) for said client device,
generating a fourth security function (V″) for said service provider,
said first and third security functions being suitable for encoding, decoding or verifying, in said client device, in combination, the services of said service provider having transmitted the request to obtain a dedicated security function and said second and fourth security functions being suitable for decoding, encoding or verifying, in said service provider, in combination, data received from the service implemented in said device.

According to certain embodiments, the method comprises:
generating a plurality of first security functions (EG) for said at least one device on the basis of said security level and said functional capabilities,
deploying said plurality of first security functions in said at least one device,
obtaining a plurality of second security functions (EV) capable of decoding, encoding or decrypting data encoded, decoded or decrypted by said first functions,
a request from a service provider to parameterise said plurality of first and second security functions,
obtaining a plurality of parameters (PG′) for
   obtaining a third security function (G′) from said plurality of first security functions, and
   obtaining a fourth security function (V′) from said plurality of second security functions,
deploying said third security function (G′) in said device,
deploying said fourth security function (V′) in said service at said service provider which has transmitted the parameterisation request.

According to certain embodiments, deploying the fourth security function comprises:
transmitting an identifier of said device to said service provider,
transmitting said fourth security function (V′) as one or other of:
the software code encoding said fourth security function,
parameters of the fourth security function enabling the service provider to create said fourth security function,
a secure access to a server of said communication network comprising the code for said fourth security function.

According to certain embodiments, the method comprises:
receiving, from a service provider, a request for singularisation of a security function intended to be used by said service of said service provider and said device, said security function being dedicated to said device when using said service, said request comprising said security level to be guaranteed.

According to certain embodiments, said security functions are chosen from one or other or a combination of the following:
an encryption function,
an authentication function,
an integrity function.

According to certain embodiments, the generation of at least one first security function (G) for said at least one client device on the basis of a security level required by said service, and of functional capabilities of said client device, comprises:
determining a set of families of parameterisable security functions,
storing the set of families of parameterisable security functions,
generating said first security function, from at least one of said stored parameterisable security functions, based on a security level required by said service and on functional capability parameters of said client device, and
generating said second security function, from at least one of said stored parameterisable security functions, based on the security level required by said service and on functional capability parameters of said client device.

According to certain embodiments, said first security function, and respectively said second security function, is obtained by:
selecting one or more functions from one or more families of parameterisable security functions, the selection being made as a function of the security level to be guaranteed and the functional capabilities of said client terminal,
setting the parameters of the at least one of said selected parameterisable security functions in order to obtain said first security function and respectively said second security function.

According to certain embodiments, said security function is obtained by composing a plurality of mathematical functions on the inputs and/or outputs of a security function in order to scramble them and create a functional variation of said security function.

According to certain embodiments, said security level is obtained from said service provider.

The invention also relates to a computer program comprising instructions for executing the method steps of the method according to the invention when said program is executed by a computer.

The invention also relates to a computer-readable storage medium on which is stored a computer program comprising instructions for executing the steps of the method according to the invention.

The invention also relates to a device for deploying a security function for at least one client device connected to the device through a communication network, said security function being intended to secure a service implemented in said client device, the deployment device comprising one or more processors configured together or separately to:
generate at least one first security function (G) for said at least one client device on the basis of a security level required by said service, and the functional capabilities of said client device,
deploy said at least one first security function in said at least one client device to guarantee implementation of said service . . .

### BRIEF DESCRIPTION OF THE DRAWINGS

FIG. 1 shows an embodiment of a system implementing embodiments of the present invention.

FIG. 2 shows an embodiment of a method according to the present invention.

FIG. 3 shows a first embodiment of an implementation of a security function deployment service,

FIG. 4 shows a second embodiment of an implementation of a security function deployment service, and

FIG. 5 shows a third embodiment of an implementation of a security function deployment service.

### DESCRIPTION OF THE EMBODIMENTS

Other features and advantages of the present invention will become apparent from the description given below, with reference to the appended drawings which illustrate an exemplary embodiment that is in no way limiting.

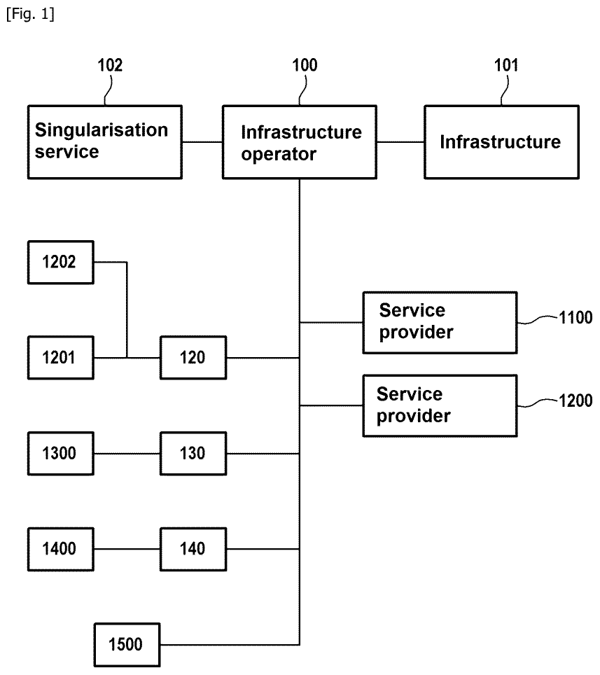

The present invention is described in a system comprising an infrastructure operator and a service provider as illustrated in FIG. 1. The infrastructure operator 100 may typically be a communications network operator or an IT service operator who has to manage network and/or IT equipment. The infrastructure operator 100 has infrastructure equipment 101 for managing the system, preferably in the form of IT equipment such as servers and databases, as well as various pieces of network equipment.

A plurality of client devices 1201, 1202, 1300, 1400 are connected to the network deployed by the infrastructure provider, via access gateways 120, 130 and 140 respectively, provided by the infrastructure provider. Access gateways are usually connected to one or more client devices via a wired or wireless local area network (LAN). They enable the connection between the local network and the network of the infrastructure operator 100. One client device 1500 is connected to the network directly, without passing through a gateway.

Two service providers 1100 and 1200 are also connected to the operator's network. This connection is made either directly or via the intermediary of one or more communication operators, as implemented on the Internet. In this particular case, service providers 1100 and 1200 are connected to the operator's network using VPN techniques or more common access techniques such as SSL, HTTPS, or any other techniques known to a person skilled in the art for interactions on the Internet. A plurality of service providers can coexist and provide services. In the context of the present invention, a service provider is typically a payment service or an identity provider, a service for delivering goods, content or services, such services requiring robust security protocol implementations.

Client devices 1201, 1202, 1300, 1400 and 1500 may be devices that comprise significant capabilities which enable them to install and use one or more services provided by the service providers. In some cases and according to the present invention, one or more of these client devices have limited capabilities that do not allow them to install one or more services provided by the service provider or providers according to the security levels required by these providers. Some of these client devices, such as SIM cards, connected objects and security elements, cannot support advanced cryptographic functions or offer enhanced security services such as secure storage. Consequently, without the present invention, they would not be able to achieve high levels of assurance in the sense of common criteria or according to the European CyberSecurityAct Directive, such as the security level of bank cards, for example.

The present invention can enable such client devices, which do not have sufficient security levels, to achieve security levels enabling them to use services provided by service operators and requiring security levels which were not originally achieved by these devices or available in these devices, as long as these devices allow additional functions or software to be added. Advantageously, this can avoid the need to replace client devices with new devices in order to implement those services that require high security functions in order to operate.

Client devices may comprise one or more components that implement the service. A component is, for example, a SIM card, a trusted execution environment (TEE), embedded IoT (Internet of Things) software or an application from a store, but can also be a dedicated storage, computing and execution environment or space within a virtual infrastructure commonly known as the Cloud, containers, Virtual Machines (VMs), microservices, etc. In the remainder of the description, reference is made to a client device but it may also be understood as a component of the client device or one or more components of the client device.

Throughout the description, the security function may be dedicated to the client device or to a component of the client device. So when referring to a security function for a client device, this may also refer to a security function for a component of the client device. Similarly, when referring to a security function for a component of the client device, this may also refer to a security function for a client device.

The infrastructure operator also accesses a singularisation service 102 which singularises a security function for one or more client terminals, according to the embodiments of the present invention. The singularisation service may be a component of the infrastructure operator 100 or may be separate from it. Typically, the singularisation service is a software module that also comprises storage resources, for example a server.

For this purpose, the embodiments described below propose a singularisation of a security function which customises the result of the calculations of the security function which will be deployed in the client device or a component thereof, in order to enable it to implement a service with a security level required by the application. In addition to enabling a component to implement a service to which it did not have access, this disclosure makes it very difficult to automate attacks on the components implementing this function. The fact that it is non-uniform and specific to each implementation makes the automating of mass cyberattacks complicated.

It is possible to singularise a function already existing in a client device by making it more secure in order to meet a need for greater security than that which it was able to provide, but also to provide a singularised security function to a client device, for example an IoT type device, initially devoid of security functions, so as to enable it to implement a service requiring a security level.

The network infrastructure operator 100 collaborates with the singularisation service 102 in order to provide client devices and service providers with security functions enabling them, as mentioned above, to implement a service in the client device, by adapting the security level of the client device to make it capable of implementing said service according to the security level required by said service.

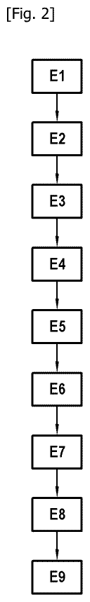

FIG. 2 shows an embodiment of the generation of a singularised security function. As new client terminals are added, the infrastructure operator can establish a list of the client terminals present behind the access gateways or directly connected to the operator's network. For this purpose, it can set up gateway or terminal interrogation mechanisms or obtain information when new terminals are connected.

In step E1, the operator associates one or more functional capabilities with the client devices by collecting their functional capabilities. This data, linking client device identifiers and their respective functional capabilities, can be stored on network infrastructure servers and updated regularly or when a client device is added or removed.

Client device identifiers may, for example, be a MAC address, an IP address, a serial number, a service identifier such as an IMSI (International Mobile Subscriber Identity), an MSISDN (number uniquely identifying a subscription on a GSM or UMTS mobile network) or an email address for communications services, or a technical contract number for services delivering goods or content, etc.

This step E1 is an optional step in the sense that the infrastructure operator may have this information spontaneously available in a different manner, without having to request it from the client terminals, for the purposes of the present invention.

Functional capabilities may comprise, but are not limited to, whether or not they possess built-in cryptographic or arithmetic libraries, and if so which ones, their available memory space, their operating system and the version thereof.

Functional capabilities can be used to determine either the nature or the complexity of the security functions that these devices can implement. In other words, the functional capabilities are linked to the security level of the singularised function that will be implemented in the client device insofar as they can determine the maximum security level that the device can implement.

When the functional capabilities are not sufficient to support the security level required by the service, it is possible either:
to ask the service provider to reduce the security level required,
to not authorise the client device to use the requested service,
to distribute the singularised service function, in part on the client device, providing it with a singularised service function compatible with its functional capabilities, and in part on at least one other device located between the client device and the service provider, for example one or more gateways such as gateways 120, 130 or 140 (or other devices present in the network), the two or more singularised functions in combination enabling the required security level to be guaranteed.

The infrastructure operator can also obtain the required security levels for each service from the service provider, step E2. These security levels can be achieved in different ways.

According to certain embodiments, service providers can transmit the security levels associated with the services they provide to the infrastructure operator. They can be transmitted when a service is deployed or stored in a database.

According to certain embodiments, these security levels can also meet standardised security criteria. For example, an application relating to a banking function may be systematically associated with a high security level. For example, the server can obtain a function code (such as a banking function code) and associate a known security level with this function code.

According to certain embodiments, the infrastructure server can ask the service provider for a security level required for its operation when the client terminal asks the infrastructure operator to install a singularised function, for example if the service is not installed on the client terminal due to the lack of a sufficient security level.

According to certain embodiments, the client device can also transmit the security level of the service it wishes to install to the infrastructure operator.

According to certain embodiments, the operator monitors market requirements and determines that a given piece of equipment needs to have a high security level. For example, if the infrastructure operator decides to use the SIM card as a medium for a digital identity card, this will require a high-level eIDAS and CSPN certification. 80% of SIM cards on the market have a sufficient security level, and the remaining 20% need to be treated to make them compatible with this high level.

The infrastructure operator obtains a set of parameterisable security function families, step E3.

A family of functions can be described as a set of mathematical functions of identical complexity and structure. Examples include, but are not limited to, the family of byte-by-byte or bit-by-bit permutations, the family consisting of one round of a Feistel scheme complexified by an algorithm of the SHA-1 type, the family consisting of modulo 65537 arithmetic operations but also any mathematical function known to a person skilled in the art in the field of mathematics, such as arithmetic operations in the ring ( [symbol] /65537 [symbol] ,+,x).

The function families are stored by the network operator 100, step E4. They can be stored on servers in the infrastructure 101.

They constitute a sort of database or catalogue of a set of families of parameterisable security functions intended to be singularised.

These steps E1 to E4 are implemented by the network operator and can be carried out independently of the following steps, upstream of them, to establish a catalogue or database of security functions.

The network operator can therefore advantageously provide a security service for service providers and give client terminals present in its network access to services requiring a higher security level than that which they natively possess. Thus, service providers can transmit a service subscription request, not shown in FIG. 2, in order to benefit from this security service, also known as singularisation. A service contract can then be concluded between the service providers 1100, 1200 and the network infrastructure operator 100.

During a step E5, a client terminal, for example terminal 1201, wishes to take advantage of a service offered by one of the service providers 1100 or 1200. It then installs the service on the terminal, in the form of software code, for example an application code. However, during installation, the service provider may alert the client terminal 1201 that it does not have the security level required to implement said service. It is also possible, without the intervention of the service provider, that the application cannot be installed because the security level of the terminal 1201 is not sufficient. More specifically, the service is associated with a security level that must be guaranteed before it can function. For example, the application requires a secure storage space on the client terminal in order to function, whereas the client terminal does not have secure storage functions. The client terminal 1201 therefore transmits a singularised security function request, this request aiming to install a singularised security function or to reinforce an existing security function, in order to guarantee a security level of said service that it wishes to install or that it has installed in order to be able to use it, step E6.

This request can comprise a plurality of parameters. In particular, it may comprise an identifier for the client terminal 1201, which enables the singularised security function which will be generated to be associated with the terminal that requested it. The identifier may already be included in one of the fields of the messages exchanged (in this case, for example, a MAC address) or may be specifically transmitted. This terminal identifier can enable remote communication with this terminal. This identifier can be, but is not limited to, an identifier relating to the terminal operating system and enabling remote communications via the terminal provider resources, a communication address on the Internet or on a telecommunications network, an identifier linked, for example, to a security component and to the operators of the underlying infrastructure, such as a SIM card and the related IMSI (International Mobile Subscriber Identity)/MSISDN (a number which uniquely identifies a subscription on a GSM or UMTS mobile network), an identifier within a dedicated instance within another security component such as the TEE (Trusted Execution Environment) specified by the GlobalPlatform consortium). It may also comprise the security service to be reinforced, for example, mutual authentication of the service provider application, authentication of the remote application, integrity and proof of origin of exchanges between the application and the service provider, but also parameters specific to the security service required. It may also comprise the security level to be guaranteed for the application that the client terminal 1201 wishes to install. This security level to be guaranteed may be expressed in different ways, for example on a scale of 1 to 10. In certain embodiments, these security levels may correspond to the levels defined in the European CyberSecurity Act Directive, which defines the following three levels: Basic, Substantial and High.

The functions used for securing are more or less complex, for example permutation functions are more complex than XOR functions. Families of permutations are therefore preferred when a high security level is required. The function family or families can therefore be selected by comparing the security level required and the complexity of the functions of the families, and by selecting the family or families for which the functions have a level of complexity that enables this security level to be obtained. In other words, a family is selected according to the security level required and the complexity of the functions it contains.

In certain embodiments, the request may also comprise parameters relating to the functional capability of the client device. In other embodiments, if the infrastructure operator does not possess the functional capabilities of the client device, then it can ask for them following receipt of the request, step E7.

The infrastructure operator then generates the singularised security function dedicated to the client terminal 1201 for use of the requested service, step E8.

According to the embodiments of the present invention, the same singularised security function can therefore be generated for terminals having identical functional capabilities and wishing to install the same service.

In a security-enhanced implementation, the infrastructure operator could guarantee the uniqueness of this singularised function for the requesting user or terminal, thus leading to implicit authentication of said terminal or user. According to certain embodiments, the singularised function generated could therefore be unique.

The singularised security function is obtained from at least one of said parameterisable security functions stored, during step E4, on the basis of said security level to be guaranteed and functional capability parameters of said client device. The singularised security function can be obtained from an automatic or random generation of functions selected from a family of functions meeting the security requirements of the service and the functional capability of the client device.

According to certain embodiments, the security function may consist of adding the security to an already existing function in the client device, in order to reinforce, or even raise, the existing security level so as to guarantee the security level required by the service to be installed on the client service for its implementation.

The security function can be obtained by composing a plurality of mathematical functions on the inputs and/or outputs of a security function in order to scramble them and create a functional variation of said security function.

According to certain embodiments, the security function can also be a function that is composed entirely by the singularisation service, also from the function catalogue, for example when the client device does not already have a security function or does not have a security function for which the level can be raised sufficiently to achieve the security level to be guaranteed for the implementation of the service.

Various types of security functions can be singularised, for example:
encryption security functions,
authentication or integrity security functions,
electronic signature security functions.

An encryption security function can be singularised based on a plurality of bijections. The dedicated security function can be obtained from an automatic or random generation of bijections selected from a family of functions, each of said generated functions then being chained upstream or downstream of the encryption function to be singularised. The automatic generation of a bijection can be based, on the one hand, on the generation of a cryptographic parameter, such as a key, and on the other hand on the random generation of a configuration parameter, for example a set of byte permutations or hash functions.

An authentication or integrity security function can be singularised using the same families of functions as those used for singularising symmetrical encryption functions, supplemented by families of non-bijective functions, families of one-way functions, each of said generated functions then being chained upstream or downstream of the authentication or integrity function to be singularised. This singularisation can be obtained by automatic or random generation of one-way functions or encryption functions selected from a family of functions.

An electronic signature security function can be obtained from secret key-based functions.

According to certain embodiments, the singularisation service may comprise a singularisation strategy manager and a singularisation logic manager.

The singularisation strategy manager is a module, preferably a software module, with a set of rules enabling it to define a singularisation logic based on a required security level and the functional capabilities of the various client devices present.

The singularisation logic manager is a module, preferably a software module, which generates a singularised function based on a singularisation logic. It forms this singularised function by selecting functions from a database of functions, such as determined in the previous step, E3.

A complete singularisation function consists of N functions selected and configured by the automatic generator from P families of functions available in the database.

The automatic singularised function generator selects an implementation of a function from within a code base organised by function family and creates a scrambling function from a function family and a setting of one or more configuration parameters and one or more cryptographic parameters. An example of a family of functions is the family of XOR functions. This family consists of a configuration parameter (the position of the bytes in the incoming data where the XOR is to be applied) and a cryptographic parameter (the value with which to perform the XOR). Similarly, in the arithmetic in the ring (Z/nZ, +,) x defines the set of possible modulo n arithmetic operations. A scrambling function that can be generated from this family is the function that performs a multiplication (configuration parameter) of an input x with a value K1 (cryptographic parameter) modulo n (configuration parameter). Within a family, functions may have the same behaviour (e.g. permutation of bit 1 and bit 4) but a different code because a particular coding technique has been used.

### Examples of Obtaining a Singularised Function

In this example, during step E3, two families of functions are determined, namely XOR and the permutation. In this example, the family of permutations is considered to be more complex than the family of XOR.

Each family has 3 codes corresponding to functions in these families. For example, the XOR family has the following functions:
X1—a javacardv3.1 code enabling an XOR to be carried out between the first n bytes of the message (configuration parameter) and a value v (cryptographic parameter),
X2—a C code enabling an XOR to be carried out of all the first bytes of the message (configuration parameter) and a value v (cryptographic parameter),
X3—a javacardv3.1 code that is functionally equivalent to the X1 code but uses a defensive development technique, such as adding instructions to scramble power consumption patterns.

The permutation family has the following codes:
P1—the C code of a permutation for an input vector of size 10 which permutes bytes a (configuration parameter<=10) and 4,
P2—the javaCard v3.1 code obfuscated by a permutation for a vector of size 10 and which performs permutations according to an order in the input parameter (configuration parameter),
P3—a code functionally equivalent to the P2 code but using the permutation function embedded in the javaCard v2.1 OS.

In this example, the security level required by the service is high, for example level 8 on a scale from 0 (lowest level) to 10 (highest level) or the high level of the European CyberSecurity Act Directive, and the functional capabilities of the client device that requested the installation of the service (for example a smart card) support javacard 3.1.

The strategy manager creates a singularisation logic that indicates a preference for high-complexity functions with obfuscation developed for javacard 3.1.

The singularisation logic manager performs a search in the catalogue based on the determined logic, and receives a list of functions to use: X3, P1 and X1. From there, the manager chooses the order in which to compose them, whether to combine them to create a new function and how to parameterise them to create the singularised function. It can also verify that it is unique to the target. For example, in the case of function X3 described above, n and v have to be parameterised. For the P1 function, a must be parameterised.

According to certain embodiments, obtaining the singularised security function comprises parameterising at least one of the selected parameterisable security functions as a function of the security level to be guaranteed and of functional capability parameters obtained from the client device 1201 in order to obtain a first singularised security function.

According to certain embodiments
the first singularised security function is obtained by
combining at least two security functions selected from at least one family of functions satisfying the security level to be guaranteed and the functional capabilities of the client device, and
setting the parameters of the selected combination of functions.

The singularised security function is then transmitted to the client device 1201 to be implemented during or with the use of the service concerned, step E9.

The security function can be transmitted in various forms to the client device 1201:
in the form of software code for said function,
in the form of a set of information enabling the client device and the service provider to construct said function, the set of information comprising:
an identifier of the transmitted security function,
an LBA list.

The identifier of the singularised function transmitted can be used to distinguish one of a plurality of singularised security functions. More specifically, the service provider or terminal may have a plurality of functions singularised for a specific use, and can therefore use an identifier to distinguish between them and know which singularised function to select to carry out the processing. This can also be useful for managing the life cycle of the function (installation/update/uninstalling).

According to certain embodiments, the infrastructure operator can transmit a code comprising a plurality of scrambling functions to the service provider or client device, instead of transmitting the code of the singularised function. For each singularised function transmitted to the client device, the infrastructure provider transmits to the service provider the means of reconstructing the dual function of the one instantiated on the equipment by indicating in the LBA list which scrambling functions are to be activated, in which order and whether they come before or after the security function to be singularised (e.g. AES). The identifier of the singularised function enables the link to be made with the dual function in the equipment. It may also be possible to do the same on the client device if it has the available memory capacity.

The security function can then be integrated into the service code deployed in the client terminal.

As mentioned above, the function can be used to secure an existing function or can constitute a function in its own right.

According to certain embodiments, the security function can be integrated into an application, a code unit present on the client device, such as an applet on a smart card in the client device. The applet code can be transmitted by the client device to the operator, which modifies the applet code by integrating the singularised security function and retransmits the applet code to the client device. The security function may be an applet itself transmitted by the service operator to the client device. According to certain embodiments, the service comprises APIs enabling it to consume the security function singularised in the applet deployed in the device or component.

A second singularised security function, dual to that installed in the client device, can be transmitted to the service provider which supplies the requested service. The first singularised function and said second singularised function collaborate to encode, decode or verify the security services instantiated between said client device and said service provider when implementing the service.

According to certain embodiments, the code of the dual function is not necessarily transmitted as such to the service provider but to an infrastructure server which the service provider can interrogate via an interface. The service provider can ask the server to verify the value returned by the singularised function in the client terminal. This can advantageously limit the distribution of singularised functions.

The first and second security functions may, for example, be encryption and decryption functions. They can be symmetrical functions, where the service provider and the client device use the same function to encrypt and decrypt, or asymmetrical functions, where the service provider and the client device each receive a singularised security function enabling them to decrypt each others messages and a singularised security function enabling them to encrypt the messages. These first and second functions can also be designed identically in the sense that the two entities carry out the same processing to ensure, for example, that the integrity of a message is maintained.

The embodiments described below detail examples where a plurality of singularised security functions work together to secure on-demand services.

According to certain embodiments, the infrastructure operator stores the singularised security functions associated with the client terminal identifier and the service. It can store the functions as such, for example in the form of software code, or information enabling these functions to be obtained, in the same way as the information transmitted to the client device and the service provider described above.

Once the singularised security function or functions have been transmitted to the client device and the service provider, additional service activation steps may be possible. For this purpose, activation can use challenge/response mechanisms to activate the service. The service provider can create a given challenge for which it knows the expected response. It transmits this challenge, then the singularised function is applied to this challenge message and returns a response that the service provider verifies. If the verification shows that the response is indeed the expected response, then the service is activated.

Once activated, the service can be used by the client device because it meets the security level expected for the implementation of the service by the service provider.

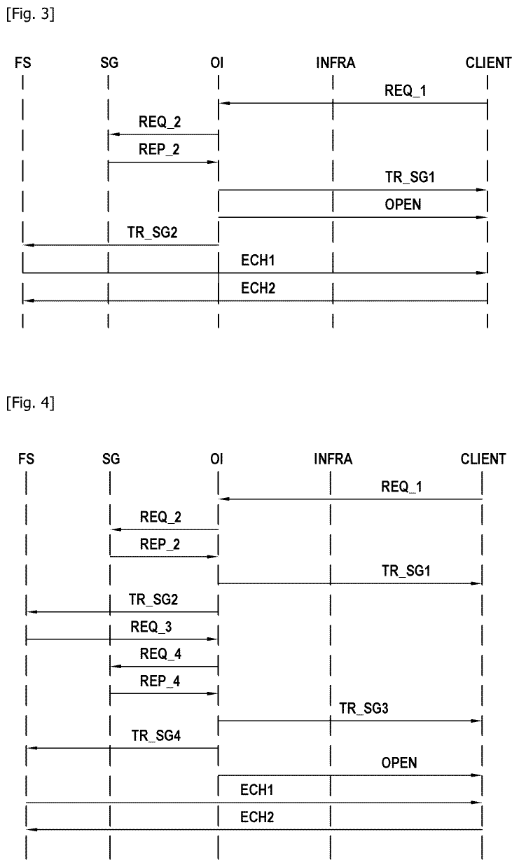

The following abbreviations are used in FIGS. 3, 4 and 5:
FS: service provider
OI: infrastructure operator
SG: singularisation service
Infra: network infrastructure
Client: client device

FIG. 3 shows a first embodiment of an implementation of a security function deployment service. It represents exchanges between devices in the system.

An optional first step may comprise a request REQ_1 from the client device. This request may comprise a request from the client device for a singularised security function. This device may wish to implement a service provided by one of the service providers, but does not have the security level required by the service provider to implement the service.

More generally, the infrastructure operator may not generate a single security function for a client terminal following a request such as the REQ_1 request, but may generate one or more security functions for each or a plurality of client terminals present in the operator's network, without waiting for a request. The infrastructure operator may advantageously have knowledge of all the client terminals, and may generate security functions for these terminals connected to the network. The operator can generate these security functions using a singularisation service, which is responsible for generating the security functions. The singularisation service, illustrated as a different device or module from the infrastructure operator for the sake of clarity, can be integrated into it, as mentioned with reference to FIG. 1. The infrastructure operator can offer a singularisation service to all service providers and all client devices. This service can be implemented on request, or following the establishment of a contract between the service provider wishing to use the singularisation service. In this way, client terminals that could not benefit from the service because they did not have the security level required by the service can raise their security level and thus implement the service. This service can also be implemented when the client device is purchased or when the client device is manufactured.

The infrastructure operator therefore requests the singularisation service for one or more security functions G for each of the client devices, request REQ_2. This can be done, as mentioned above, following a request from the client device, but more generally automatically by the infrastructure operator, for example when said client device is connected to the network. The singularisation service can generate a security function as described with reference to FIG. 2. The security function or functions G or the parameters enabling this security function or this plurality of security functions G to be created, determined or obtained are transmitted by the singularisation device to the operator in a message REP_2. The infrastructure operator transmits the information relating to this or these first security functions to the client devices in a message TR_SG1. The singularisation service registers the function or functions G.

In addition to the at least one security function determined for each client device, the singularisation service can determine one or more singularised security functions V capable of collaborating with the security function or functions transmitted to the client device. Collaboration can be understood to mean decoding data generated by the at least one first security function or encoding data intended for the at least one first security function. The singularisation service registers the function or functions V. In other words, the first security function and the second security function collaborate to encode, decode or verify the security service to be secured between the client device and the service provider when implementing the service.

The infrastructure operator transmits the singularised security function or functions V to the service provider, enabling it to collaborate with the functions G in the TR_SG2 message. In addition to the information relating to the singularised security functions V, the infrastructure operator can transmit an identifier of the client device to which the function G is transmitted. This identifier may be different from or identical to the identifier that the infrastructure operator uses to communicate with or identify the client terminal in the network. This identifier can be an identifier generated for the communications implemented between the service provider and the client terminal when the service is implemented. This identifier can also be a set of data enabling the user device and the component to be identified, for example an IP address, an application identifier such as the application identifier (AID), standardised identifier for applications that can be installed on a smart card.

As mentioned above, the information relating to these security functions can be transmitted
in the form of software code for the function,
in the form of a set of information enabling the client device and the service provider to construct the function, the set of information possibly comprising:

an identifier of the transmitted security function,
an LBA list,
a secure access to a server including the code of the transmitted security function.

It may be noted that the form in which the information transmitted to the client device relating to this or these first security functions in the TR_SG1 message may be different from the form in which the information is transmitted to the client service provider relating to this or these second security functions, in the TR_SG2 message.

Optionally, the infrastructure operator can transmit a message to the client device giving it rights to use the singularisation service, in the OPEN message. This message may, for example, be transmitted following a usage request, for example the REQ_1 request, or following a subscription to the singularisation service which itself follows a service request to the service provider. The infrastructure operator can, for example, distribute a token to the service provider, which can be verified by the user equipment and which indicates the right to consume the singularised function. It is effectively envisaged that the steps in FIG. 3 comprise, prior to the steps indicated in FIG. 3, one or more steps comprising:
a request from the client device to the service provider to implement (or use) a service,
a response from said service provider indicating to said terminal that it does not have the security level required to implement the requested service, or
a response from said service provider indicating to said terminal that it must request activation of the singularisation service from the infrastructure operator in order to implement the requested application.

Activation steps ECH_1 and ECH_2 can be implemented to use the singularised function G and the inverse function V. The activation steps ECH_1 and ECH_2 may consist of a first successful exchange between the service provider and the client device. They may be performed in a different order to that shown in FIG. 3 (ECH_2 before ECH_1). This activation can use a “challenge-response” mechanism. The service provider can create a given challenge for which it knows the expected response. It transmits this challenge, then the singularised function is applied to this challenge message and returns a response that the service provider verifies. If the verification shows that the response is indeed the expected response, then the service is activated.

According to certain embodiments, the singularisation service determines two singularised functions G1 and V2 for the client device, and G2 and V1 for the service provider. Advantageously, this enables the security to be reinforced by differently scrambling messages going from the client terminal to the service provider and messages going from the service provider to the client terminal.

Advantageously, the functions G and V are bijections and can be used in mirror image, i.e. V can be used to encrypt or scramble and G to decrypt or unscramble.

Functions G and V may be security functions per se, and may be scrambling functions added before a security function and/or after a security function.

Thus, according to certain embodiments, G and V comprise one or more scrambling functions and a function scrambled by the scrambling function or functions, it being possible for the function to be existing in the device.

According to certain embodiments, G and V can be security functions created entirely by the singularisation service.

FIG. 4 shows a second embodiment of an implementation of a security function deployment service. It represents exchanges between devices in the system.

The REQ_1, REQ_2, REP_2, TR_SG1, TR_SG2 messages may be identical to those described with regard to FIG. 3. Thus, once the function or functions G and V have been deployed, the service provider would like an additional singularisation or customisation of its service, namely a dedicated singularisation. For this purpose, it requests a singularisation function for each service or for all of its services. This singularisation or customisation is combined with the singularisation function linked to the component and described above. This has the advantage of reinforcing the security of the services. According to FIG. 3, a different singularization is dedicated to each client device that uses the services of a service provider. According to FIG. 4:
A client device A using a service B1 from a service provider FS1 may have a different singularised function than when using a service B2 from a service provider FS2, or
A client device A using a service S1 from a service provider FS1 may benefit from a different singularised function than when using a service S1′ from the same service provider FS1.

The service provider transmits a request REQ_3 for a dedicated secure function on its behalf.

According to certain embodiments, this dedicated secure function request may be dedicated to one or more, or even all, of the services offered by the service provider. The service provider can transmit a dedicated REQ_3 request for each of its services, so it can transfer as many requests as the services that it offers. It can also transmit an REQ_3 request for all of its services.

The infrastructure operator transmits a singularisation request, for the service provider or for a particular service of the service provider, to the singularisation service. The singularisation service then determines a third singularisation function G′ and a fourth singularisation function V′. The singularisation service stores the functions G′ and V′.

The third singularisation function G′ is transmitted to the device, message TR_SG3, and the fourth singularisation function V′ is transmitted to the service provider, message TR_SG4.

Messages TR_SG3 and TR_SG4 can comprise the fourth singularization function in the form of:
software code for the function,
a set of information enabling the client device and the service provider to construct the function, said set of information possibly comprising:
an identifier of the transmitted security function,
an LBA list,
a secure access to a server including the code of the transmitted security function.

In this way, the service provider and the client device both have singularisation functions specific to the client device, G and G′, and specific to the service provider, V and V′. The two functions are combined to provide a new singular security function. The two functions G and G′ can be combined simply by applying them one after the other (function G is applied to the result of function G′, or vice versa) and the same applies to functions V and V′, to make encoding and decoding (or encryption/decryption) possible.

The security function can therefore be:

$${V}^{″} = {VoV}^{′} or {V}^{″} = {VoV}^{′} \qquad [ MATH . 1 ]$$

$${G}^{″} = {GoG}^{′} or {G}^{″} = {GoG}^{′} \qquad [ MATH . 2 ]$$

As mentioned above, when the component or client device does not have sufficient functional capabilities to guarantee the security level, then the security function can be distributed over several entities on a path between the client device and the service provider, respecting conditions pre-established by the infrastructure operator and the service provider. According to certain embodiments, the functions G and G′ can be distributed, one on the client device, G for example, and the other, G′, on a gateway located between the client device and the service provider. In this embodiment, the functional capabilities of the client device are not sufficient to implement the security level to be guaranteed, but they are sufficient to implement a function G with a lower security level. The security level to be guaranteed, which is guaranteed by the combination of functions G and G′, is then guaranteed by distributing G and G′, if the access gateway has the functional capabilities to implement function G′.

Once the security functions have been deployed on the device and the provider, the infrastructure operator can transmit a message to the client device, giving it rights to use the singularisation service, in the OPEN message.

The activation steps ECH_1 and ECH_2 can be implemented enabling the singularised function G and the inverse function V to be used. The activation steps ECH_1 and ECH_2 may consist of a first successful exchange between the service provider and the client device. They may be performed in a different order to that shown in FIG. 3 (ECH_2 before ECH_1). This activation can use a “challenge-response” mechanism. The service provider can create a given challenge for which it knows the expected response. It transmits this challenge, then the singularised function is applied to this challenge message and returns a response that the service provider verifies. If the verification shows that the response is indeed the expected response, then the service is activated.

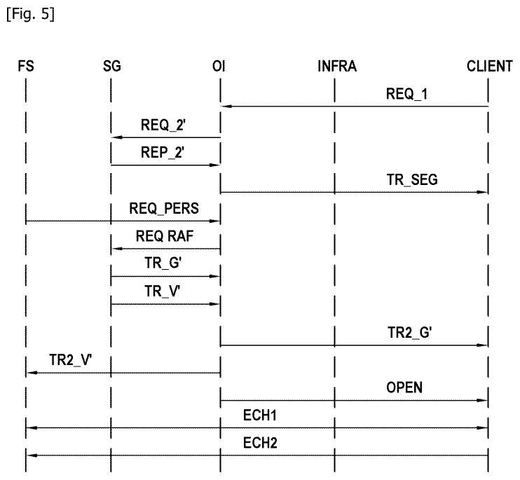

FIG. 5 shows a third embodiment of an implementation of a security function deployment service. It represents exchanges between devices in the system.

In this embodiment, the infrastructure operator asks the singularisation service for a plurality of EG security functions for each of the client devices, request REQ_2′. This request may be identical to the REQ_2 request in which the infrastructure operator specifies that it is requesting a plurality of security functions for a single client terminal. This plurality of security functions EG is a set of parameterisable security functions.

In addition to the set of security functions determined for each client device, the singularisation service can determine a set of singularised security functions EV capable of collaborating with the security function or functions transmitted to the client device. Collaboration can be understood to mean decoding and descrambling data generated by the at least one first security function or encoding and scrambling data intended for the at least one first security function. These sets of security functions EG and EV are stored in the singularisation service.

The set of singularised security functions EG is transmitted to the client device in a message TR_SEG.

The service provider transmits a request REQ_PERS for a dedicated secure function, for itself or for one of its services.

According to certain embodiments, this dedicated secure function request may be dedicated to one or more, or even all, of the services offered by the service provider. The service provider can transmit a dedicated request REQ_PERS for each of its services, so it can transfer as many requests as the services that it offers. It can also transmit a REQ_PERS request for all of its services.

The infrastructure operator transmits a singularisation request, for the service provider or for a particular service of the service provider, to the singularisation service REQ_RAF. The singularisation service then determines the parameters PG′ used to generate a security function G′ on the client device for use by the service or for the service provider. This security function is generated from the set of functions EG. The singularisation service generates the corresponding security function V′ that can collaborate with the function G′, as explained above for functions G′ and V′ (or G and V) from the set of functions EV.

The singularisation service also stores the parameters PG′ and the function V′.

The singularisation service transmits the function V′ in a message TR_V′ and the function G′ in a message TR_G′ to the infrastructure operator.

The infrastructure operator transmits the functions G′ and V′ to the client device and the service provider respectively in a message TR2_G′ and TR2_V′.

The TR2_G′ message may comprise the singularization function in the form:
of the software code for G′,
specifications enabling the service provider to reconstitute G′,
a secure access to a server containing the code for G′.

The TR2_V′ message may comprise the singularization function in the form:
of the software code for V′,
specifications enabling the service provider to reconstruct V′,
a secure access to a server containing the code for V′.

Optionally, the infrastructure operator can transmit a message to the client device giving it rights to use the singularisation service, in the OPEN message.

Activation steps ECH_1 and ECH_2 can be implemented to use the singularised function G′ and the inverse function V′.

The activation steps ECH_1 and ECH_2 may consist of a first successful exchange between the service provider and the client device. They may be performed in a different order to that shown in FIG. 3 (ECH_2 before ECH_1). This activation can use a “challenge-response” mechanism. The service provider can create a given challenge for which it knows the expected response. It transmits this challenge, then the singularised function is applied to this challenge message and returns a response that the service provider verifies. If the verification shows that the response is indeed the expected response, then the service is activated.

In the preceding embodiments, an optional step is envisaged in which the service provider can transmit, to the infrastructure operator, a security level required by one or more of its services, for example in the form of a contract. The contract may comprise details relating to the security levels required for the services or applications, as well as the way in which the dual singularisation functions are made available to the service provider, i.e. via a server provided by the infrastructure operator, which the service provider can interrogate via an interface without necessarily having access to the code, or by transmitting or deploying a code. The contract can also set out how the singularised function is deployed on the component and where potential functions G′ or G″ can be deployed. In particular, the contract can also specify what happens when the functional capabilities of the device are not sufficient to guarantee the required level of service, as indicated above. The service can specify that it wishes either:
to request the service provider to reduce the security level required,
to not authorise the client device to use the requested service, or
to distribute the singularised service function, in part on the client device, providing it with a singularised service function compatible with its functional capabilities, and in part on at least one other device located between the client device and the service provider, for example a gateway such as gateways 120, 130 or 140, the two singularised functions in combination enabling the required security level to be guaranteed.

According to certain embodiments, the methods described above and their variants as described are implemented in the form of a computer program comprising instructions for executing the steps of the method according to the embodiments of the invention when said program is executed by a computer. According to certain embodiments, these programs are stored on a computer-readable storage medium.

Throughout the description, the term “obtain” is used to mean determine, create or receive.

The present invention also relates to a method of generating a first security function, implemented in a network comprising a plurality of client devices, said security function being intended to secure a service implemented in at least one of said client devices, the method comprising,
obtaining a set of families of parameterisable security functions,
storing the set of families of parameterisable security functions,
receiving, from a client device, a request to secure a service in order to guarantee a security level associated with said service,
obtaining said first security function, from at least one of said stored parameterisable security functions, based on a security level to be guaranteed and on functional capability parameters of said client device,
transmitting said first security function to said client device.

The present invention can advantageously resolve this security incompatibility between the security level required by a service and the level of service offered by the device wishing to benefit from the service, by adding cryptographic components or scrambling functions specific to each instance or variant made available to a user. The present invention can resolve this incompatibility by functional singularisation of the security services made available to a user's device.

According to certain embodiments, the method comprises
transmitting, to an operator of said network, a request for a first security function to guarantee a security level when said service is implemented,
receiving the first security function determined on the basis of at least one functional capability of the client device and the security level to be guaranteed in order to implement the service.

According to certain embodiments, said first security function is obtained by:
selecting one or more functions from one or more families of parameterisable security functions, the selection being made as a function of the security level to be guaranteed and the functional capabilities of said client terminal,
setting the parameters of at least one of said selected parameterisable security functions in order to obtain said first security function.

According to certain embodiments, the method comprises, prior to the request for a security function, installing, in said client device, a service provided by a service provider, said service being associated with said security level to be guaranteed, said security level being higher than a security level available in said client device.

According to certain embodiments, said first security function is obtained by:
combining at least two security functions selected from at least one family of functions satisfying the security level to be guaranteed and the functional capabilities of the client device, and
setting the parameters of said selected combination of functions.

According to certain embodiments, the method comprises:
transmitting a second security function (V) to said service provider, said first function and said second security function collaborating to encode or decode communications between said client device and said service provider when implementing said service.

According to certain embodiments, the method comprises:
transmitting an identifier of said client device to said service provider, enabling said second security function to be associated with said client device.

According to certain embodiments, the first and second security functions are transmitted to said client device and said service provider respectively.
in the form of software code for said function,
in the form of a set of information enabling said client device and said service provider to construct said function, said set of information comprising:
an identifier of said transmitted security function,
a list comprising scrambling functions used for said first and second security functions, and the order in which they are used.

According to certain embodiments, the security function is obtained by composing a plurality of mathematical functions on the inputs and/or outputs of a security function in order to scramble them and create a functional variation of said security function.

According to certain embodiments, a family of parameterisable security functions comprises a set of cryptographic functions of identical complexity and structure, a family being able to be chosen from:
a family of byte-by-byte permutations or
a family consisting of one round of a Feistel scheme complexified by a hash algorithm.
a family consisting of modulo 65537 arithmetic operations.

The invention also relates to a terminal in a communications network comprising an infrastructure operator, said terminal comprising one or more processors configured, together or separately, to:
transmit, to an operator of said network, a request for a first security function to guarantee a security level when implementing a service,
receive the first security function determined on the basis of at least one functional capability of the terminal and the security level to be guaranteed in order to implement the service.

1. A method for deploying a security function for at least one client device connected to a communication network, said security function being intended to secure a service implemented in said client device, the method being implemented by a device of an infrastructure operator of said communication network, and comprising:
generating at least one first security function for said at least one client device as a function of a security level required by said service, and
deploying said at least one first security function in said at least one client device to guarantee implementation of said service.

2. The method of claim 1, wherein said first security function is generated as a function of a security level required by said service and of functional capabilities of said client device.

3. The method of claim 1, further comprising:
generating at least one second security function, said first security function and said second security function collaborating to encode, decode or verify data of the service to be secured between said client device and a service provider providing said service, when implementing the service, and
deploying said at least one second security function in said service on a server of said service provider.

4. The method of claim 3, further comprising:
receiving a request from a service provider to obtain a security function dedicated to one or all of the services it provides,
generating a third security function for said client device, and
generating a fourth security function for said service provider,
said first and third security functions being suitable for encoding, decoding or verifying, in said client device, in combination, the services of said service provider having transmitted the request to obtain a dedicated security function, and said second and fourth security functions being suitable for decoding, encoding or verifying, in said service provider, in combination, data received from the service implemented in said device.

5. The method of claim 1, further comprising:
generating a plurality of first security functions for said at least one device as a function of said security level,
deploying said plurality of first security functions in said at least one device,
obtaining a plurality of second security functions suitable for decoding, encoding or decrypting data encoded, decoded or decrypted by said first security functions,
receiving a request from a service provider to parameterise said plurality of first and second security functions,
obtaining a plurality of parameters for
obtaining a third security function from said plurality of first security functions, and
obtaining a fourth security function from said plurality of second security functions,
deploying said third security function in said device, and
deploying said fourth security function in said service at said service provider which has transmitted the parameterisation request.

6. The method of claim 4, wherein deploying the fourth safety function comprises:
transmitting an identifier of said device to said service provider,
transmitting said fourth security function as one or other of:
software code encoding said fourth security function,
parameters of the fourth security function enabling the service provider to create said fourth security function, and
a secure access to a server of said communication network comprising the code for said fourth security function.

7. The method of claim 1, further comprising,
receiving, from a service provider, a request for singularisation of a security function intended to be used by said service of said service provider and said device, said security function being dedicated to said device when using said service, said request comprising said security level to be guaranteed.

8. The method of claim 1, wherein said security functions are chosen from one or other or a combination of the following:
an encryption function,
an authentication function, and
an integrity function.

9. The method of claim 3, wherein generating at least one first security function for said at least one client device as a function of a security level required by said service comprises:
determining a set of families of parameterisable security functions,
storing the set of families of security functions,
generating said first security function, from at least one of said stored security functions, as a function of the security level required by said service, and
generating said second security function, from at least one of said stored security functions, as a function of the security level required by said service.

10. The method of claim 9, wherein said first security function, and respectively said second security function, is obtained by:
selecting one or more functions from one or more families of security functions, the selection being made as a function of the security level to be guaranteed and the functional capabilities of said client terminal, and
setting the parameters of the at least one of said selected parameterisable security functions, in order to obtain said first security function and respectively said second security function.

11. The method claim 1, wherein said security function is obtained by composing a plurality of mathematical functions on the inputs and/or outputs of a security function in order to scramble them and create a functional variation of said security function.

12. The method of claim 1, wherein said security level is obtained from said service provider.

13. (canceled)

14. A non-transitory, computer-readable storage medium on which is stored a computer program comprising instructions which, when executed by a processor, cause the processor to implement the method of claim 1.

15. A device for deploying a security function for at least one client device connected to the device through a communication network, said security function being intended to secure a service implemented in said client device, the deployment device comprising one or more processors configured together or separately to:
generate at least one first security function for said at least one client device as a function of a security level required by said service, and the functional capabilities of said client device, and
deploy said at least one first security function in said at least one client device to guarantee the implementation of said service.
